(19) United States
(12) Patent Application Publication
(10) Pub. No.: US 2014/0322440 A1
(43) Pub. Date: Oct. 30, 2014

(54) METHOD FOR MANUFACTURING OPTICAL MEMBER

(71) Applicant: NITTO DENKO CORPORATION, Osaka (JP)

(72) Inventors: Takahiro NONAKA, Osaka (JP); Hiroaki KISHIOKA, (US); Hirofumi KATAMI, Osaka (JP)

(73) Assignee: NITTO DENKO CORPORATION, Osaka (JP)

(21) Appl. No.: 14/263,282

(22) Filed: Apr. 28, 2014

(30) Foreign Application Priority Data
Apr. 30, 2013 (JP) 2013-094882

(51) Int. Cl. G02B 1/10

(52) U.S. Cl. CPC G02B 1/10
USPC 427/165

(57) ABSTRACT

A method for manufacturing an optical member includes forming a printed layer on one surface of a sheet substrate or flat-plate substrate. The method further includes coating one or more pressure-sensitive adhesives selected from the group consisting of a hot melt pressure-sensitive adhesive and an active energy-ray curable pressure-sensitive adhesive on a surface on a printed layer side of the sheet substrate or flat-plate substrate, and forming a pressure-sensitive adhesive layer of the pressure-sensitive adhesive.

### BACKGROUND OF THE INVENTION

1. Technical Field

The present disclosure relates to a method for manufacturing an optical member.

2. Background Art

Optical members such as a touch sensor are widely used in a liquid crystal display device, an organic EL (electroluminescence) display device, a PDP (plasma display panel), an electronic paper and the like.

Some of there optical members have a printed layer. Examples thereof include a capacitance touch sensor. The touch sensor has been conventionally manufactured by printing on cover glass (a printed layer) and laminating a film-type sensor (a film sensor) through a double-sided pressure-sensitive adhesive sheet (for example, Patent Document 1).

In the touch sensor, the purpose of the printed layer is to hide an electrode of the film sensor as well as the design reason, and the printed layer was generally black. This is because the hiding property (the property to be not transparent by light from the backlight) is necessary. Recently however, light colors such as while are sometimes required for the design. A while printed layer has to be very thick in comparison with the conventional black printed layer in order to achieve similar hiding property as in the black printed layer, and for example, the white printed layer is necessary to be 4 to 8 times thicker than the black printed layer. In the case where the printed layer is thick, there have been problems in that a warp due to the step difference of the printed layer (printing step difference), which is not noticeable in the conventional printed layer that is relatively thin, becomes very large and the appearance deteriorates. FIG. 10 is a schematic diagram showing an example of the conventional method for manufacturing an optical member in which a thick printed layer such as a white printed layer is used. As shown in FIG. 10, a warp part 103 is generated in the case where a printed layer 12 is provided on one surface of a sheet substrate or flat-plate substrate 11 and a film 102 such as a film sensor is laminated through a double-sided pressure-sensitive adhesive sheet 101.

The warp due to the printing step difference was sometimes large and the appearance deteriorated also in optional members other than a touch sensor.

As a technique for solving the above problems, it is disclosed that a liquid resin is used instead of a double-sided pressure-sensitive adhesive sheet (for example, Patent Document 2).

Patent Document 1: JP-A-2010-077287

Patent Document 2: JP-A-2012-117028

### SUMMARY OF THE INVENTION

However, the liquid resin above had problems such as the liquid leakage and the difficulty in curing the printing step difference part.

Accordingly, an object of the present disclosure is to provide a method for manufacturing an optical member which has no warp due to the printing step difference and has an excellent appearance. Alternatively, an object thereof is to provide a method for manufacturing an optical member to be used for an optical member which has no warp due to the printing step difference and has an excellent appearance.

As a result of extensive studies to solve the above problems, the present inventors have found that it is possible to obtain an optical member which has no warp due to the printing step difference and has an excellent appearance or it is possible to obtain an optical member to be used for an optical member which has no warp due to the printing step difference and has an excellent appearance, by manufacturing an optical member by a manufacturing method including: forming a printed layer on one surface of a sheet substrate or flat-plate substrate; and coating one or more pressure-sensitive adhesives selected from the group consisting of a hot melt pressure-sensitive adhesive and an active energy-ray curable pressure-sensitive adhesive on a surface on a printed layer side of the substrate, and forming a pressure-sensitive adhesive layer of the pressure-sensitive adhesive. Thus, the present inventors have completed the present invention.

The present disclosure provides the following method for manufacturing an optical member.

(1) A method for manufacturing an optical member, including:

forming a printed layer on one surface of a sheet substrate or flat-plate substrate; and

coating one or more pressure-sensitive adhesives selected from the group consisting of a hot melt pressure-sensitive adhesive and an active energy-ray curable pressure-sensitive adhesive on a surface on a printed layer side of the sheet substrate or flat-plate substrate, and forming a pressure-sensitive adhesive layer of the pressure-sensitive adhesive.

(2) The method according to (1), wherein a warp index of the optical member manufactured is 0 to 0.5 μm, the warp index being defined below:

warp index: when a polyethylene terephthalate film having a thickness of 100 μm is laminated to a surface of the pressure-sensitive adhesive layer of the optical member manufactured, a surface roughness of a surface of the polyethylene terephthalate film on the side opposite to the pressure-sensitive adhesive layer is measured, the max value and min value of the surface roughness is calculated, and the warp index is determined by the following formula (A).

warp index(μm)=(max value)−(min value) (A)

The method for manufacturing an optical member in one aspect of the present disclosure can provide an optical member which has no warp and has an excellent appearance even in the case where the printing step difference is large, by the method including forming a specific pressure-sensitive adhesive layer on the surface on the printed layer side of a sheet substrate or flat-plate substrate. In addition, the method for manufacturing an optical member in one aspect of the present disclosure can provide an optical member to be used for an optical member which has no warp and has an excellent appearance even in the case where the printing step difference is large, by the method including forming a specific pressure-sensitive adhesive layer on the surface on the printed layer side of a sheet substrate or flat-plate substrate.

### BRIEF DESCRIPTION OF THE DRAWINGS

FIG. 1 is a schematic diagram showing an example of the step (i) and the step (ii) of the method for manufacturing an optical member in one aspect of the present disclosure.

FIG. 2 is a schematic diagram showing an example of the step (iii) of the method for manufacturing an optical member in one aspect of the present disclosure.

FIG. 3 is a schematic diagram showing an example of the step (iv) of the method for manufacturing an optical member in one aspect of the present disclosure.

FIG. 4 is a schematic diagram showing an example of the laminate (laminate (b)) obtained by the step (ii).

FIG. 5 is a schematic diagram showing an example of the laminate obtained by the step (i), the step (ii) and the step (iii).

FIG. 6 is a schematic diagram showing an example of the laminate obtained by the step (i), the step (ii) and the step (iv).

FIG. 7 is a schematic diagram showing an example of the specific embodiment (1) of the method for manufacturing an optical member in one aspect of the present disclosure.

FIG. 8 is a schematic diagram showing an example of the specific embodiment (1) of the method for manufacturing an optical member in one aspect of the present disclosure.

FIG. 9 is a schematic diagram showing an example of the specific embodiment (2) of the method for manufacturing an optical member in one aspect of the present disclosure.

FIG. 10 is a schematic diagram showing an example of the conventional method for manufacturing an optical member.

### DETAILED DESCRIPTION OF THE INVENTION

One aspect of the present disclosure relates to a method for manufacturing an optical member, including at least a step of forming a printed layer on one surface of a sheet substrate or flat-plate substrate and a step of coating one or more pressure-sensitive adhesives selected from the group consisting of a hot melt pressure-sensitive adhesive and an active energy-ray curable pressure-sensitive adhesive on a surface on a printed layer side of the sheet substrate or flat-plate substrate, and forming a pressure-sensitive adhesive layer of the pressure-sensitive adhesive. In the present specification, “the method for manufacturing an optical member, including at least a step of forming a printed layer on one surface of a sheet substrate or flat-plate substrate and a step of coating one or more pressure-sensitive adhesives selected from the group consisting of a hot melt pressure-sensitive adhesive and an active energy-ray curable pressure-sensitive adhesive on a surface on a printed layer side of the sheet substrate or flat-plate substrate” is sometimes referred to as “the manufacturing method of the present disclosure”.

In the present specification, “the step of forming a printed layer on one surface of a sheet substrate or flat-plate substrate” is sometimes referred to as the “step (i)”. Further, “the step of coating one or more pressure-sensitive adhesives selected from the group consisting of a hot melt pressure-sensitive adhesive and an active energy-ray curable pressure-sensitive adhesive on a surface on a printed layer side of the sheet substrate or flat-plate substrate, and forming a pressure-sensitive adhesive layer of the pressure-sensitive adhesive” is sometimes referred to as the “step (ii)”.

The manufacturing method of the present disclosure may contain other step(s) (which is sometimes referred to as the “other step” below) in addition to the step (i) and the step (ii).

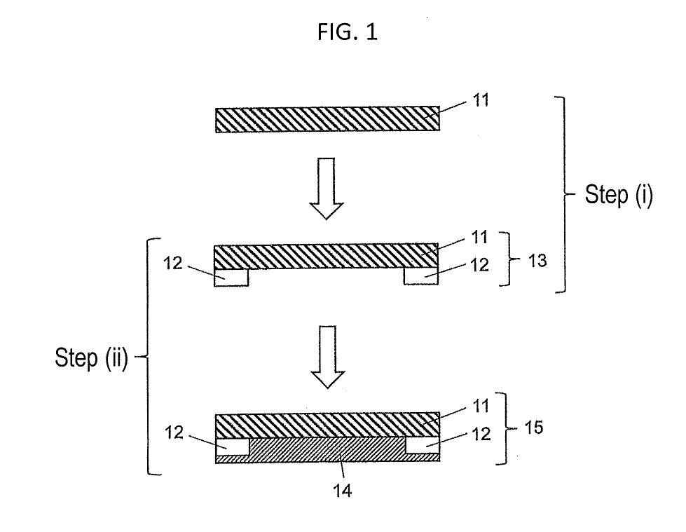

FIG. 1 is a schematic diagram showing an example of the step (i) and the step (ii) in the manufacturing method of the present disclosure. A printed layer 12 is first formed on one surface of a sheet substrate or a flat-plate substrate 11 and thus a laminate (a) 13 is produced. Then, a pressure-sensitive adhesive layer 14 of the present disclosure is formed on the surface on the printed layer 12 side of the substrate 11, and a laminate (b) 15 is produced.

[Step (i)]

The step (i) is a step of forming a printed layer on one surface of a sheet substrate or flat-plate substrate.

### (Sheet Substrate or Flat-Plate Substrate)

The sheet substrate or flat-plate substrate means a substrate having a sheet shape or a substrate having a flat-plate shape. The sheet substrate or flat-plate substrate is not particularly limited, and from the viewpoint of the transparency, preferable examples thereof include a glass substrate such as a glass base plate; and a plastic substrate such as a plastic base plate or a plastic film. One kind of these sheet substrates or flat-plate substrates may be used alone or two or more kinds thereof may be used in combination.

The material of the plastic substrate is not particularly limited, and examples thereof include a polyester-based resin such as polyethylene terephthalate (PET), an acrylic resin such as polymethyl methacrylate (PMMA), polycarbonate, triacetylcellulose (TAC), polysulfone, polyarylate, polyimide, polyvinyl chloride, polyvinyl acetate, polyethylene, polypropylene, an ethylene-propylene copolymer, and a cyclic olefin polymer such as trade name “ARTON (a cyclic olefin polymer; manufactured by JSR Corporation)” and trade name “ZEONOR (a cyclic olefin polymer; manufactured by ZEON CORPORATION)”. Among them, from the viewpoint of the workability and the transparency, PET, PMMA, polycarbonate and a cyclic olefin polymer are preferable. One kind of these materials of the substrate may be used alone or two or more kinds thereof may be used in combination.

The sheet substrate is not particularly limited and is preferably a plastic film among the substrates exemplified as the sheet substrate or flat-plate substrate above. Further, the material of the plastic film is not particularly limited and is preferably PET, polycarbonate or a cyclic olefin polymer among the materials exemplified as the material of the plastic substrate above. That is, the sheet substrate is preferably a PET film, a polycarbonate film or a cyclic olefin polymer film. One kind of these substrates may be used alone or two or more kinds thereof may be used in combination. As the commercially available product, for example, non-orientation films such as trade name “ARTON” (manufactured by JSR Corporation) and trade name “ZEONOR” (manufactured by ZEON CORPORATION) can be used.

The thickness of the sheet substrate is not particularly limited and is preferably 5 to 100 μm. The sheet substrate may have a single-layer form or a multiple-layer form. In addition, the surface of the sheet substrate may be appropriately subjected to conventional surface treatment such as physical treatment (corona discharge treatment, plasma treatment and the like) or chemical treatment (undercoating treatment and the like).

The flat-plate substrate is not particularly limited and a glass base plate and a plastic base plate are preferable among the substrates exemplified as the sheet substrate or flat-plate substrate above. The material of the plastic base plate is not particularly limited, and PMMA and polycarbonate are preferable among the materials exemplified as the material of the plastic substrate above. That is, as the flat-plate substrate, a glass base plate, a PMMA base plate or a polycarbonate base plate is preferable. One kind of these substrates may be used alone or two or more kinds thereof may be used in combination.

The thickness of the flat-plate substrate is not particularly limited and is preferably 100 to 500 μm. The flat-plate substrate may have a single-layer form or a multiple-layer form. In addition, the surface of the flat-plate substrate may be appropriately subjected to conventional surface treatment such as physical treatment (corona discharge treatment, plasma treatment and the like) or chemical treatment (undercoating treatment and the like).

The total light transmittance (in accordance with JIS K7361-1) in the visible light wavelength range of the sheet substrate or flat-plate substrate is not particularly limited, and is preferably 85% or more and more preferably 88% or more. Further, the haze (in accordance with JIS K7136) of the substrate is not particularly limited, and is preferably 1.0% or less and more preferably 0.5% or less.

### (Printed Layer)

The printed layer is not particularly limited and conventional printed layers can be used. The printed layer contains, for example, a binder resin and a color material, although it is not particularly limited. In addition, a dispersant, a cross-linking agent, a photopolymerization initiator, a sensitizer and the like may be contained if needed.

The binder resin is not particularly limited and examples thereof include general resins (thermoplastic resins, thermocurable resins, photocurable resins and the like) such as a polyurethane-based resin, a phenolic resin, an epoxy-based resin, an urea-melamine-based resin, a silicone-based resin, a phenoxy resin, a methacrylic resin, an acrylic resin, a polyarylate resin, a polyester-based resin (e.g. polyethylene terephthalate and the like), polyolefin-based resin (e.g. polyethylene, polypropylene, an ethylene-propylene copolymer and the like), a polystyrene-based resin (polystyrene, a styrene-acrylonitrile copolymer, a styrene-butadiene copolymer, a styrene-maleic anhydride copolymer, an acrylonitrile-butadiene-styrene resin and the like), polyvinyl chloride, a vinyl chloride-vinyl acetate copolymer, polyvinyl acetate, polyvinylidene chloride, polycarbonate, cellulose (e.g. a cellulose acetate resin, an ethyl cellulose resin and the like), polyacetal and the like. One kind of these binder resins may be used alone or two or more kinds thereof may be used in combination.

The color material is not particularly limited and conventional pigments, dyes and the like can be used. Specific examples thereof include the while color material, the silver color material, the black color material, the cyan color material, the magenta color material, the yellow color material and the like that are described in JP-A-2011-214010. One kind of these color materials may be used alone or two or more kinds thereof may be used in combination.

The printed layer may have a single-layer form or a multiple-layer form. Although it is not particularly limited, the multiple-layer form is preferable from the viewpoint of further improving the hiding property. In the case where the printed layer has a multiple-layer form, the layer number of the printed layer is 2 or more and may be appropriately determined within the range of 2 to 10, and the layer number is preferably 2 to 6.

The thickness of the printed layer is not particularly limited, and is preferably 25 to 100 μm, more preferably 35 to 90 μm and further preferably 45 to 80 μm. In the case where the thickness of the printed layer is 25 μm or more, the printing step difference becomes sufficiently large and the warp generated by manufacturing the optical member in accordance with the conventional method becomes large. Accordingly, it is more effective to adopt the manufacturing method of the present disclosure in order to prevent the warp, which is an object of the present disclosure. Further, the thickness of the printed layer of 100 μm or less is advantageous in terms of the printing cost.

### (Method for Forming Printed Layer)

The method for forming the printed layer on one surface of the sheet substrate or flat-plate substrate is not particularly limited and conventional methods for forming a printed layer can be used. Specific examples thereof include a method of coating a composition for forming the printed layer on one surface of the substrate, and drying, thermally curing or curing with active energy-ray if needed, a method using various printing methods (gravure printing method, flexo printing method, offset printing method, letterpress method, screen printing method and the like), a method using a deposition method and the like. One kind of these formation methods may be conducted alone or two more methods thereof may be used in combination.

The composition for forming the printed layer may contain a dispersant, a cross-linking agent, a solvent, a photopolymerization initiator, a sensitizer and the like if needed, in addition to the binder resin and the color material.

In the step (i), the printed layer may be formed on the whole surface of one surface of the substrate or may be partially foamed on one surface of the substrate. An embodiment of partially forming the printed layer on one surface of the substrate is not particularly limited, and examples thereof include an embodiment of forming the printed layer along the edge of the substrate (for example, an embodiment of forming the printed layer like a frame form in the case where the substrate is rectangular), an embodiment of forming a design pattern with the printed layer on one surface of the substrate, or the like. Among them, the embodiment of forming the printed layer along the edge of the substrate is preferable from the viewpoint of using it for a general touch panel.

A laminate having a structure of [sheet substrate or flat-plate substrate/printed layer] is produced by the step (i). The laminate is sometimes referred to as “a laminate (a)”.

[Step (ii)]

The step (ii) is a step of coating one or more pressure-sensitive adhesives selected from the group consisting of a hot melt pressure-sensitive adhesive and an active energy-ray curable pressure-sensitive adhesive on the surface on the printed layer side of the sheet substrate or flat-plate substrate, and flaming a pressure-sensitive adhesive layer of the pressure-sensitive adhesive, after the step (i). In the present specification, the “one or more pressure-sensitive adhesives selected from the group consisting of a hot melt pressure-sensitive adhesive and an active energy-ray curable pressure-sensitive adhesive” is sometimes referred to as “the pressure-sensitive adhesive of the present disclosure”. The step (ii) is a step of coating the pressure-sensitive adhesive of the present disclosure on the surface on the printed layer side of the laminate (for example, the laminate (a) which has been produced in the previous step, and then, forming a pressure-sensitive adhesive layer of the pressure-sensitive adhesive of the present disclosure. Further, the “pressure-sensitive adhesive layer formed by coating the pressure-sensitive adhesive of the present disclosure”, namely the “pressure-sensitive adhesive layer formed by coating one or more pressure-sensitive adhesives selected from the group consisting of a hot melt pressure-sensitive adhesive and an active energy-ray curable pressure-sensitive adhesive on the surface on the printed layer side of the sheet substrate or flat-plate substrate” is sometimes referred to as “the pressure-sensitive adhesive layer of the present disclosure”.

### (Pressure-Sensitive Adhesive of the Present Disclosure)

The pressure-sensitive adhesive of the present disclosure is one or more pressure-sensitive adhesives selected from the group consisting of a hot melt pressure-sensitive adhesive and an active energy-ray curable pressure-sensitive adhesive. The “one or more pressure-sensitive adhesives selected from the group consisting of a hot melt pressure-sensitive adhesive and an active energy-ray curable pressure-sensitive adhesive” means both of a hot melt pressure-sensitive adhesive and an active energy-ray curable pressure-sensitive adhesive, or either of a hot melt pressure-sensitive adhesive or an active energy-ray curable pressure-sensitive adhesive. One kind of the pressure-sensitive adhesive of the present disclosure may be used alone or two or more kinds of the pressure-sensitive adhesives may be used in combination. If the pressure-sensitive adhesive is one or more pressure-sensitive adhesives selected from the group consisting of a hot melt pressure-sensitive adhesive and an active energy-ray curable pressure-sensitive adhesive, the amount of volume decreased in the case of coating and forming a pressure-sensitive adhesive layer is small, and it is thus possible to manufacture an optical member which has no warp and has an excellent appearance in the case where a film such as a film sensor is then laminated, even if the printing step difference is large. On the other hand, if the pressure-sensitive adhesive is a solvent pressure-sensitive adhesive, because the amount of volume is largely decreased by coating and drying, the warp due to the large printing step difference is generated and the appearance deteriorates.

The hot melt pressure-sensitive adhesive is not particularly limited and conevntional pressure-sensitive adhesives such as a rubber-based pressure-sensitive adhesive, an urethane-based pressure-sensitive adhesive (e.g. an acrylic urethane-based pressure-sensitive adhesive), an acrylic pressure-sensitive adhesive, a silicone-based pressure-sensitive adhesive, a polyester-based pressure-sensitive adhesive, a polyamide-based pressure-sensitive adhesive, an epoxy-based pressure-sensitive adhesive, a vinyl alkyl ether-based pressure-sensitive adhesive or a fluorine-based pressure-sensitive adhesive can be used. Among them, the rubber-based pressure-sensitive adhesive and the urethane (acrylic urethane)-based pressure-sensitive adhesive are particularly preferable. In addition, one kind of the hot melt pressure-sensitive adhesives may be used alone or two or more kinds thereof may be used in combination.

As the rubber-based pressure-sensitive adhesive, for example, a rubber-based pressure-sensitive adhesive containing natural rubber or synthetic rubber as the base polymer is exemplified. Examples of the rubber-based pressure-sensitive adhesive containing synthetic rubber as the base polymer include styrene-based rubber (also called a styrene-based elastomer) such as styrene-butadiene (SB) rubber, styrene-isoprene (SI) rubber, styrene-isoprene-styrene block copolymer (SIS) rubber, styrene-butadiene-styrene block copolymer (SBS) rubber, styrene-ethylene-butylene-styrene block copolymer (SEBS) rubber, styrene-ethylene-propylene-styrene block copolymer (SEPS) rubber, styrene-ethylene-isoprene-styrene block copolymer (SIPS) rubber and styrene-ethylene-propylene block copolymer (SEP) rubber, polyisoprene rubber, regenerated rubber, butyl rubber, polyisobutylene and modified rubber thereof. Among them, a styrene-based elastomer pressure-sensitive adhesive is preferable and SIS and SBS are more preferable. One kind of the rubber-based pressure-sensitive adhesive may be used alone or two or more kinds thereof may be used in combination.

The active energy-ray curable pressure-sensitive adhesive is not particularly limited and examples thereof include rubber-based pressure-sensitive adhesives containing natural rubber or synthetic rubber (such as polyisoprene rubber, styrene-butadiene rubber, styrene-isoprene-styrene block copolymer rubber, styrene-butadiene-styrene block copolymer rubber, regenerated rubber, butyl rubber and polyisobutylene) as the base polymer; and acrylic pressure-sensitive adhesives containing as the base polymer an acrylic polymer (monopolymer or copolymer), which uses one kind or two or more kinds of alkyl (meth)acrylate as the monomer component. Among them, an acrylic pressure-sensitive adhesive is preferable.

The content of the acrylic polymer contained in the acrylic pressure-sensitive adhesive is not particularly limited, and is preferably 96 to 100 wt % and more preferably 98 to 100 wt % from the viewpoint of the odor.

The acrylic polymer is not particularly limited and preferable examples thereof include an acrylic polymer constituted from an alkyl (meth)acrylate having a linear or branched alkyl group and/or alkoxyalkyl (meth)acrylate having a linear or branched alkyl group as the essential monomer component. The “(meth)acryl” means “acryl” and/or “methacryl” (one or both of “acryl” and “methacryl”), and the same meansing is applied hereinafter.

Further, the monomer component to constitute the acrylic polymer is not particularly limited, and a polar group-containing monomer, a polyfunctional monomer or a copolymerizable monomer other than the monomer components above (which is sometimes referred to as “other copolymerizable monomer” below) may be contained.

The alkyl (meth)acrylate having a linear or branched alkyl group (which is sometimes referred to as just “alkyl (meth)acrylate”) is not particularly limited and examples thereof include alkyl (meth)acrylates in which the carbon atom number of the alkyl group is 1 to 20, such as methyl (meth)acrylate, ethyl (meth)acrylate, propyl (meth)acrylate, isopropyl (meth)acrylate, butyl (meth)acrylate (n-butyl (meth)acrylate), isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate and eicosyl (meth)acrylate. One kind of these alkyl (meth)acrylates may be used alone or two or more kinds thereof may be used in combination. Among them, 2-ethylhexyl acrylate (2EHA), isooctyl acrylate (i-OA) and butyl acrylate (BA) are preferable.

The content of the alkyl (meth)acrylate and/or the alkoxyalkyl (meth)acrylate is not particularly limited, and is preferably 50 to 98 wt % and more preferably 50 to 95 wt % based on the total amount (100 wt %) of the monomer components to constitute the acrylic polymer from the viewpoint of the pressure-sensitive adhesive strength and the stress relaxation property. In the case where both of the alkyl (meth)acrylate and the alkoxyalkyl (meth)acrylate are used as the monomer components, it is appropriate that the total amount (total content) of the content of the alkyl (meth)acrylate and the content of the alkoxyalkyl (meth)acrylate satisfies the above range.

The polar group-containing monomer is not particularly limited and examples thereof include a carboxyl group-containing monomer (including an acid anhydride group-containing monomer) such as (meth)acrylic acid; a hydroxyl group-containing monomer such as hydroxyalkyl (meth)acrylate (for example, 2-hydroxyethyl (meth)acrylate and 3-hydroxypropyl (meth)acrylate), vinyl alcohol and allyl alcohol; an amide group-containing monomer such as (meth)acrylamide; an amino group-containing monomer such as aminoethyl (meth)acrylate; an epoxy group-containing monomer such as glycidyl (meth)acrylate; a cyano group-containing monomer such as (meth)acrylonitrile; a hetero ring-containing vinyl monomer such as N-vinyl-2-pyrrolidone; a sulfonic acid group-containing monomer such as sodium vinylsulfonate; a phosphoric acid group-containing monomer such as 2-hydroxyethyl acryloyl phosphate; an imide group-containing monomer such as cyclohexyl maleimide and isopropyl maleimide; and an isocyanate group-containing monomer such as 2-methacryloyloxyethyl isocyanate. One kind of these polar group-containing monomers may be used alone or two more kinds thereof may be used in combination.

The polyfunctional monomer means a monomer having two or more ethylenically unsaturated groups in one molecule thereof. The ethylenically unsaturated group is not particularly limited and examples thereof include radical polymerizable functional groups such as a vinyl group, a propenyl group, an isopropenyl group, a vinylether group (a vinyloxy group) and an allylether group (an allyloxy group). The alkyl (meth)acrylate, the alkoxyalkyl (meth)acrylate, the polar group-containing monomer and the other copolymerizable monomer are monomers having only one ethylenically unsaturated group in one molecule thereof (mono functional monomers).

The polyfunctional monomer is not particularly limited and examples thereof include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate and urethane acrylate. One kind of the polyfunctional monomers may be used alone or two or more kinds thereof may be used in combination.

The other copolymerizable monomer is not particularly limited and examples thereof include (meth)acrylic acid ester other than the alkyl (meth)acrylate, the polar group-containing monomer and the polyfunctional monomers, for example, alicyclic hydrocarbon group-containing (meth)acrylic acid ester such as cyclopentyl (meth)acrylate, cyclohexyl (meth)acrylate and isobornyl (meth)acrylate, and aromatic hydrocarbon group-containing (meth)acrylic acid ester such as phenyl (meth)acrylate, phenoxyethyl (meth)acrylate and benzyl (meth)acrylate; vinyl esters such as vinyl acetate and vinyl propionate; aromatic vinyl compounds such as styrene and vinyltoluene; olefins or dienes such as ethylene, butadiene, isoprene and isobutylene; vinyl ethers such as vinyl alkyl ether; and vinyl chloride.

The pressure-sensitive adhesive of the present disclosure may contain a conventional additive such as a silane coupling agent, a photopolymerization initiator, a cross-linking agent (such as an isocyanate-based cross-linking agent and an epoxy-based cross-linking agent), a cross-linking accelerator, a tackifying resin (such as a rosin derivative, a polyterpene resin, a petroleum resin and oil-soluble phenol), an anti-ageing agent, a filler, a coloring agent (such as a pigment and a dye), a UV absorbent, an oxidation inhibitor, a chain transfer agent, a plasticizer, a softening agent, a surfactant and an antistatic agent, if needed, though it is not particularly limited.

The photopolymerization initiator is not particularly limited, and examples thereof include a benzoin ether-based photopolymerization initiator, an acetophenon-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenon-based photopolymerization initiator, a ketal-based photopolymerization initiator, a thioxanthone-based photopolymerization initiator and the like. One kind of these photopolymerization initiators may be used alone or two or more kinds thereof may be used in combination.

### (Method for Forming Pressure-Sensitive Adhesive Layer of the Present Disclosure)

The surface on the printed layer side of the substrate, on which the pressure-sensitive adhesive of the present disclosure is coated (applied) and the pressure-sensitive adhesive layer is formed, means the surface of the printed layer in the case where the printed layer is formed on the whole surface of the substrate; and means the surface of the substrate where the printed layer is not formed and the surface of the printed layer where the printed layer is formed in the case where the printed layer is partially formed on one surface of the substrate.

The method for forming the pressure-sensitive adhesive layer of the present disclosure is not particularly limited and conventional methods for forming a pressure-sensitive adhesive layer can be used. In the case where the pressure-sensitive adhesive of the present disclosure is the hot melt pressure-sensitive adhesive, although it is not particularly limited, the pressure-sensitive adhesive is coated in a melt state by heating, followed by cooling, thereby forming the pressure-sensitive adhesive layer of the present disclosure.

In the case where the pressure-sensitive adhesive of the present disclosure is the active energy-ray curable pressure-sensitive adhesive, although it is not particularly limited, the pressure-sensitive adhesive of the present disclosure is coated, followed by irradiating the pressure-sensitive adhesive with active energy-ray, thereby forming the pressure-sensitive adhesive layer of the present disclosure.

In the case where the pressure-sensitive adhesive of the present disclosure is the hot melt and active energy-ray curable pressure-sensitive adhesive, the pressure-sensitive adhesive layer may be formed by either of the forming method for the hot melt pressure-sensitive adhesive above and the forming method for the active energy-ray curable pressure-sensitive adhesive above, or may be formed by using both forming methods sequentially or simultaneously.

The method for coating the pressure-sensitive adhesive of the present disclosure is not particularly limited and conventional coating methods may be used. Specific examples thereof include coating methods using a coating device (coater) such as a gravure roll coater, a reverse roll coater, a kiss roll coater, a dip roll coater, a bar coater, a knife coater, a spray coater, a comma coater, a direct coater, a fountain die coater, a T-die coater, a roll coater and a gravure coater. In the case where the pressure-sensitive adhesive of the present disclosure is the hot melt pressure-sensitive adhesive, a roll coater or a gravure coater are preferable among them. On the other hand, in the case where the pressure-sensitive adhesive of the present disclosure is the active energy-ray curable pressure-sensitive adhesive, a roll coater or a comma coater are preferable among them.

Examples of the active energy-ray include an ionizing radial ray such as an alpha ray, a beta ray, a gamma ray, a neutron ray and an an electron ray, and UV. Among them, UV is preferable. As the device (active energy-ray irradiation device) for applying the active energy-ray is not particularly limited and conventional active energy-ray irradiation devices can be used. Examples thereof include an ultraviolet generation lamp (UV lamp) and an EB (electron beam) irradiation device. As the UV lamp, for example, high-pressure discharge lamps such as a metal halide lamp and a high-pressure mercury lamp, and low-pressure discharge lamps such as a chemical lamp, a black light lamp and an insect-trap fluorescent lamp are preferable.

The illumination intensity of the active energy-ray (especially UV) applied for forming the pressure-sensitive adhesive layer of the present disclosure is not preferably limited, and is preferably 1 to 20 mW/cm² and more preferably 1 to 15 mW/cm². In the case where the active energy-ray is applied, a separator (a release liner) or the like may be laminated to the surface of the coated pressure-sensitive adhesive of the present disclosure with the purpose of oxygen insulation, although it is not particularly limited. As the separator, a conventional release paper or the like can be used. The separator can be formed by conventional methods. Further, the thickness of the separator and the like are not particularly limited, either.

The thickness of the pressure-sensitive adhesive layer, which is formed by coating the pressure-sensitive adhesive of the present disclosure, is not particularly limited, and is preferably 10 to 200 μm and more preferably 25 to 200 μm. By adjusting the thickness to 10 μm or more, the adhesive reliability is excellent. Further, by adjusting the thickness to 200 μm or less, the total thickness can be reduced. Although the thickness of the pressure-sensitive adhesive layer of the present disclosure is not particularly limited, but the pressure-sensitive adhesive layer is preferably thicker than the printed layer. Here, the thickness of the pressure-sensitive adhesive layer of the present disclosure means the thickness of the thickest part of the pressure-sensitive adhesive layer. That is, in the case where the printed layer is formed on the whole surface of the substrate in the laminate (b), the thickness of the pressure-sensitive adhesive layer is the thickness of the pressure-sensitive adhesive layer from the uppermost part of the printed layer to the pressure-sensitive adhesive layer surface. On the other hand, in the case where the printed layer is partially formed on the substrate surface in the laminate (b), the thickness thereof is the thickness of the pressure-sensitive adhesive layer from the substrate surface part on which the printed layer is not formed to the pressure-sensitive adhesive layer surface.

The gel fraction of the pressure-sensitive adhesive layer of the present disclosure is not particularly limited, and is preferably 80 wt % (%) or less (for example, 30 to 80 wt %), more preferably 50 to 80 wt % and further preferably 55 to 75 wt %. By adjusting the gel fraction to 80 wt % or less, the flexibility of the pressure-sensitive adhesive layer improves and it becomes easy to laminate the pressure-sensitive adhesive layer to an optical member. The gel fraction (proportion of solvent-insoluble components) can be determined as the components insoluble in ethyl acetate. Specifically, the gel fraction is determined as the proportion of the weight of insoluble components after immersion of the pressure-sensitive adhesive layer in ethyl acetate at 23° C. for 7 days to the weight of the pressure-sensitive adhesive layer before the immersion.

More specifically, for example, the gel fraction is the value calculated by the “Method for measuring gel fraction” below.

### (Method for Measuring Gel Fraction)

About 0.1 g of the pressure-sensitive adhesive layer of the present disclosure is sampled, wrapped with a porous tetrafluoroethylene sheet having an average pore diameter of 0.2 μm (trade name “NTF1122”, manufactured by Nitto Denko Corporation) and then bound with a kite string. The weight thereof is measured and referred to as the weight before the immersion. The weight before the immersion is the total weight of the pressure-sensitive adhesive layer of the present disclosure (the pressure-sensitive adhesive layer sampled above), the tetrafluoroethylene sheet and the kite string. Further, the total weight of the tetrafluoroethylene sheet and the kite string is also measured and is referred to as the wrapping weight.

Next, the pressure-sensitive adhesive layer of the present disclosure wrapped with the tetrafluoroethylene sheet and bound with the kite string (which is referred to as the “sample”) is introduced to a 50 mL container filled with ethyl acetate and placed still at 23° C. for 7 days. Then, the sample (after ethyl acetate treatment) is taken out of the container and moved to an aluminum cup, and ethyl acetate is removed by drying in a drying machine at 130° C. for 2 hours. The weight is then measured and referred to as the weight after the immersion.

The gel fraction is calculated according to the following formula.

Gel fraction(wt %)=(A−B)/(C−B)×100

(In the formula above, A is the weight after the immersion, B is the wrapping weight and C is the weight before the immersion.)

The gel fraction can be controlled, for example by the amount (content) of the polyfunctional monomer.

By the step (ii), a laminate having the structure of [sheet substrate or flat-plate substrate/printed layer/pressure-sensitive adhesive layer of the present disclosure] is produced. The laminate is sometimes referred to as a “laminate (b)”. The laminate (b) is not particularly limited and may contain other layer(s) (such as an intermediate layer, an undercoating layer and a separator) in addition to the above structure. By using the laminate (b), an optical member which has no warp due to the printing step difference and has an excellent appearance can be manufactured.

A 180° peeling pressure-sensitive adhesive force to a glass plate at 23° C. (which is referred to as “the pressure-sensitive adhesive force (23° C.)”) of the laminate (b) (the pressure-sensitive adhesive layer surface of the laminate (b)) is not particularly limited, and is preferably 5 N/20 mm or more and more preferably 7N/20 mm or more (and for example, 30 N/20 mm or less). By adjusting the pressure-sensitive adhesive force (23° C.) to 5 N/20 mm or more, the adhesive reliability is excellent. The pressure-sensitive adhesive force (23° C.) can be measured by conducting the 180° peel test at 23° with a glass plate as an adherend (in accordance with JIS Z0237 (2000), tensile speed: 300 mm/minute).

The warp index of the laminate (b), namely the warp index of the laminate (b) defined as follows, is not particularly limited, and is preferably 0 to 0.5 μm, more preferably 0 to 0.3 μm and further preferably 0 to 0.2 μm. In the case where the warp index is 0.5 μm or less, an image can be watched without any warp.

Warp index: when a polyethylene terephthalate film (PET film) having a thickness of 100 μm is laminated to a surface of the pressure-sensitive adhesive layer of the optical member manufactured in accordance with the manufacturing method of the present disclosure, a surface roughness of a surface of the polyethylene terephthalate film on a side opposite to the pressure-sensitive adhesive layer is measured, the max value and min value of the surface roughness is calculated, and the warp index is determined by the following formula (A).

Warp Index(μm)=(max value)−(min value) (A)

### [Other Step(s)]

As the other step(s) (the step(s) other than the step (i) and the step (ii)) is not particularly limited and examples thereof include a step of proving each member on both surfaces of the laminate (b) (which is sometimes referred to as a “step (iii)”), a step of proving a member on one surface of the laminate (b) (which is sometimes referred to as a “step (iv)”), and a step of providing a member on the substrate surface of the laminate (a) which is opposite to the side having the printed layer. Among them, the step (iii) or the step (iv) is preferable. That is, the manufacturing method of the present disclosure preferably includes the step (i) and the step (ii), includes the step (i), the step (ii) and the step (iii) or includes the step (i), the step (ii) and the step (iv), although it is not particularly limited.

The step (iii) is not particularly limited and examples thereof include a step including a stage of laminating a member (member (I)) to the surface of the laminate (b) on the side of the pressure-sensitive adhesive layer of the present disclosure, and a stage of laminating a member (member (II)) to the surface of the sheet substrate or flat-plate substrate side of the laminate (b) through a pressure-sensitive adhesive layer (other pressure-sensitive adhesive layer) other than the pressure-sensitive adhesive layer of the present disclosure.

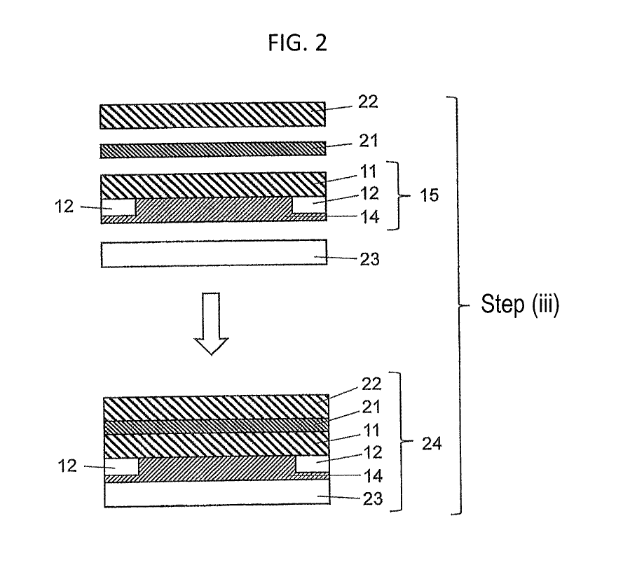

FIG. 2 is a schematic diagram showing an example of the step (iii) of the method for manufacturing an optical member in one aspect of the present disclosure. The other pressure-sensitive adhesive layer 21 and the member (I) 22 are formed on the surface of the substrate 11 of the laminate (b) 15 and the member (II) 23 is formed on the surface of the pressure-sensitive adhesive layer 14 of the present disclosure, and thus the laminate 24 is produced. It is possible to interchange the positions of the member (I) 22 and the member (II) 23.

The members (the member (I) and the member (II)) are not particularly limited, and from the viewpoint of the transparency, preferable examples thereof include a glass member such as a glass base plate; and a plastic member such as a plastic base plate or a plastic film. More preferable examples thereof include a glass base plate; or a plastic base plate or a plastic film using PMMA, polycarbonate, PET or a cyclic olefin polymer as the material. Further preferable examples thereof include a glass base plate, a PET film, a polycarbonate film, a cyclic olefin polymer film, a PMMA base plate or a polycarbonate base plate.

The member (I) and the member (II) are each selected from the above members. The combination of the member (I) and the member (II) is not particularly limited, and preferable examples thereof include a combination of a glass base plate and a plastic film, and a combination of a plastic base plate and a plastic film, and more preferable examples thereof include a combination of a glass base plate and a PET film, and a combination of a glass base plate and a cyclic olefin polymer film. It is possible to interchange the positions of the member (I) and the member (II).

The forms of the members are not particularly limited and examples thereof include a sheet, a flat-plate and the like.

The members are not particularly limited and examples thereof include a polarizing plate, a wave plate, a retardation plate, an optical compensation film, a brightness enhancing film, a light guide plate, a reflective film, an anti-reflective film, a transparent conductive film (such as an ITO film), a design film, a decoration film, a surface protective film, a film sensor, a liquid crystal display device, a liquid crystal panel, an organic EL (electroluminescence) display device, a PDP (plasma display panel) and cover glass.

The other pressure-sensitive adhesive layer is not particularly limited and conventional pressure-sensitive adhesive layers can be used. The other pressure-sensitive adhesive layer includes the meaning of the form of a pressure-sensitive adhesive sheet (pressure-sensitive adhesive tape). Although it is not particularly limited, the other pressure-sensitive adhesive layer may be the pressure-sensitive adhesive layer of the present disclosure or a commercially available pressure-sensitive adhesive sheet.

Although it is not particularly limited, the other pressure-sensitive adhesive layer may be formed by laminating a pressure-sensitive adhesive sheet to the substrate surface of the laminate (b) or to the member, or by coating a pressure-sensitive adhesive on the substrate surface of the laminate (b) or on the member and then drying and/or curing if needed. Among them, from the viewpoint of the step reduction, it is preferable that the other pressure-sensitive adhesive layer is formed by laminating a pressure-sensitive adhesive sheet to the substrate surface of the laminate (b) or to the member.

The thickness of the other pressure-sensitive adhesive layer is not particularly limited, and is preferably 10 to 250 μm and more preferably 50 to 200 μm from the viewpoint of the module design.

The step (iv) is not particularly limited and examples thereof include a step of providing a member (member (III)) on the surface of the pressure-sensitive adhesive layer of the present disclosure in the laminate (b).

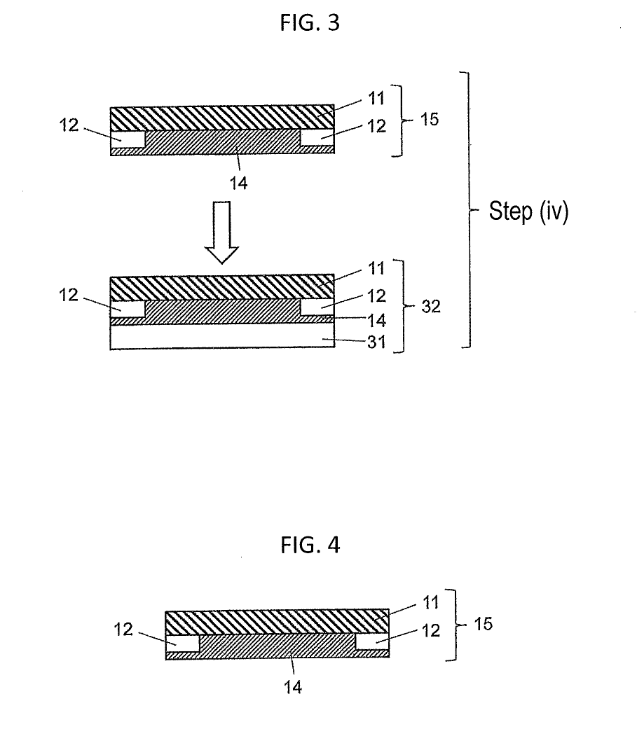

FIG. 3 is a schematic diagram showing an example of the step (iv) of the method for manufacturing an optical member in one aspect of the present disclosure. The member (III) 31 is formed on the pressure-sensitive adhesive layer 14 of the present disclosure in the laminate (b) 15, and thus, the laminate 32 is produced.

The member (III) is not particularly limited, and for example, the members exemplified as the member (I) and the member (II) above can be used. Among them, from the viewpoint of the transparency, preferable examples thereof include a glass member or a plastic member: more preferable examples thereof include a glass base plate; and a plastic base plate or plastic film using PMMA, polycarbonate, PET or a cyclic olefin polymer as the material: and further preferable examples thereof include a glass base plate, a PET film, a polycarbonate film, a cyclic olefin polymer film, a PMMA base plate or a polycarbonate base plate.

FIG. 4 is a schematic diagram showing an example of the laminate (laminate (b)) produced by the step (ii). The laminate (b) 15 has the structure of [sheet substrate or flat-plate substrate 11/printed layer 12/pressure-sensitive adhesive layer 14 of the present disclosure].

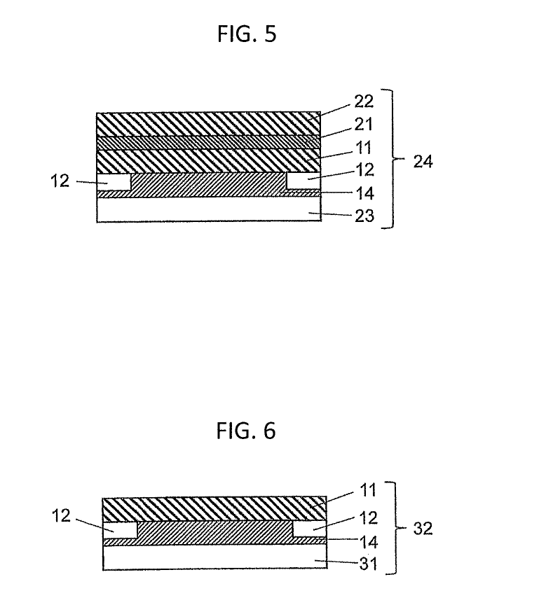

FIG. 5 is a schematic diagram showing an example of the laminate produced by the step (i), the step (ii) and the step (iii). The laminate 24 has the structure of [member (I) 22/other pressure-sensitive adhesive layer 21/sheet substrate or flat-plate substrate 11/printed layer 12/pressure-sensitive adhesive layer 14 of the present disclosure/member (II) 23], or the structure of [member (II)/other pressure-sensitive adhesive layer/sheet substrate or flat-plate substrate/printed layer/pressure-sensitive adhesive layer of the present disclosure/member (I)] though this structure is not shown in FIG. 5. The laminate may include other layer(s) (for example, an intermediate layer such as a printed layer, an undercoating layer and a separator) in addition to the above structures, though it is not particularly limited.

FIG. 6 is a schematic diagram showing an example of the laminate produced by the step (i), the step (ii) and the step (iv). The laminate 32 has the structure of [sheet substrate or flat-plate substrate 11/printed layer 12/pressure-sensitive adhesive layer 14 of the present disclosure/member (III) 31]. The laminate may include other layer(s) (for example, an intermediate layer such as a printed layer, an undercoating layer and a separator) in addition to the above structure, though it is not particularly limited.

The laminate (laminate (b)) obtained by the step (ii) can be used as a part of an optical member such as a touch sensor by laminating a member to both or one of the surfaces of the laminate (b). The laminate obtained by the step (i), the step (ii) and the step (iii) and the laminate obtained by the step (i), the step (ii) and the step (iv) can be used as a touch sensor.

Particularly preferable specific embodiments of the manufacturing method in one aspect of the present disclosure among the above embodiments are explained below.

### Specific Embodiment (1) of Manufacturing Method of the Present Disclosure

The specific embodiment (1) is an example of the method for manufacturing an optical member, the method including the step (i), the step (ii) and the step (iii). The specific embodiment (1) is an example of the method for manufacturing an optical member, the method including a step of forming a printed layer on one surface of a sheet substrate or flat-plate substrate (corresponding to the step (i)), a step of coating a pressure-sensitive adhesive selected from the group consisting of a hot melt pressure-sensitive adhesive and an active energy-ray curable pressure-sensitive adhesive on the surface on the printed layer side of the substrate, and forming a first pressure-sensitive adhesive layer (corresponding to the pressure-sensitive adhesive layer of the present disclosure) of the pressure-sensitive adhesive (corresponding to the step (ii)), a step of laminating a first member (corresponding to the member (I)) to the surface of the substrate which is opposite to the side having the printed layer side through a second pressure-sensitive adhesive layer (corresponding to the other pressure-sensitive adhesive layer), and a step of laminating a second member (corresponding to the member (II)) to the first pressure-sensitive adhesive layer.

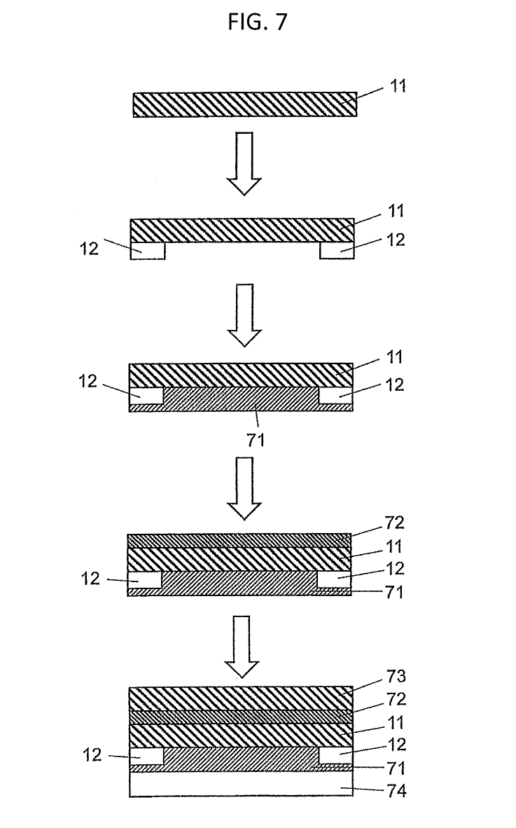

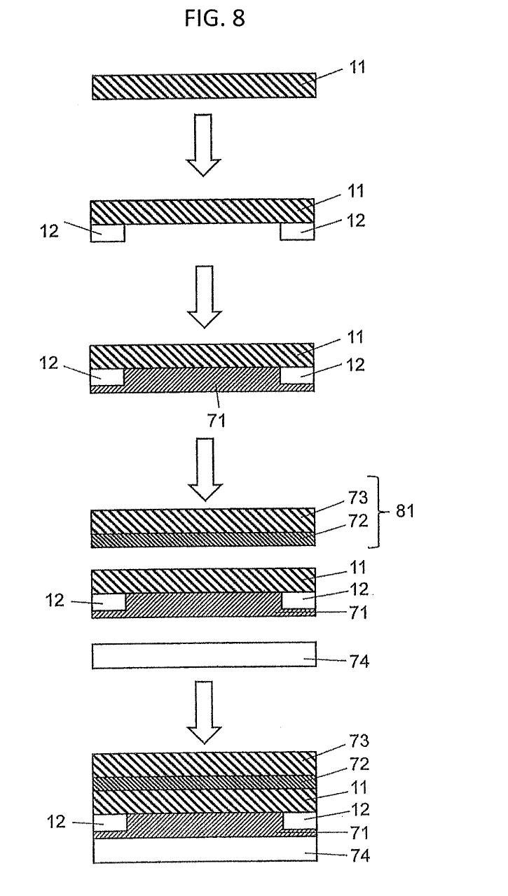

FIG. 7 and FIG. 8 are schematic diagrams showing examples of the specific embodiment (1) of the method for manufacturing an optical member in one aspect of the present disclosure. In FIG. 7, the printed layer 12 is first formed on one surface of the sheet substrate or flat-plate substrate 11. Then, the first pressure-sensitive adhesive layer 71 is formed on the surface on the printed layer 12 side of the sheet substrate or flat-plate substrate 11. Next, the second pressure-sensitive adhesive layer 72 is formed on the surface of the sheet substrate or flat-plate substrate 11 which is opposite to the side where the printed layer 12 has been formed. Then, the first member 73 is laminated to the second pressure-sensitive adhesive layer 72 and the second member 74 is laminated to the first pressure-sensitive adhesive layer 71 to thereby produce the laminate. On the other hand, in FIG. 8, the printed layer 12 is first formed on one surface of the sheet substrate or flat-plate substrate 11. Next, the first pressure-sensitive adhesive layer 71 is formed on the surface on the printed layer 12 side of the sheet substrate or flat-plate substrate 11. Then, the laminate 81, in which the second pressure-sensitive adhesive layer 72 has been formed on the first member 73, is laminated to the surface of the sheet substrate or flat-plate substrate 11 which is opposite to the side where the printed layer 12 has been formed, and the second member 74 is laminated to the first pressure-sensitive adhesive layer 71 to thereby produce the laminate.

The sheet substrate or flat-plate substrate in the specific embodiment (1) is not particularly limited, and from the viewpoint of the workability, preferable examples thereof include a plastic film, and more preferable examples thereof include a PET film, a polycarbonate film and a cyclic olefin polymer film.

The thickness of the sheet substrate or flat-plate substrate in the specific embodiment (1) is not particularly limited and is preferably 5 to 100 μm. The substrate may have a single-layer form or a multiple-layer form. In addition, the surface of the substrate may be appropriately subjected to conventional surface treatment such as physical treatment (corona discharge treatment, plasma treatment and the like) or chemical treatment (undercoating treatment and the like).

The first member and the second member are not particularly limited, and from the viewpoint of the transparency, preferable examples thereof include a glass member and a plastic member. More preferable examples thereof include a glass base plate; and a plastic base plate or plastic film using PMMA, polycarbonate, PET or a cyclic olefin polymer as the material. Further preferable examples thereof include a glass base plate, a PET film, a polycarbonate film, a cyclic olefin polymer film, a PMMA base plate and a polycarbonate base plate.

The first member and the second member are each selected from the above members. The combination of the first member and the second member is not particularly limited and preferable examples thereof include a combination of a glass base plate and a plastic film, and a combination of a plastic base plate and a plastic film, and more preferable examples thereof include a combination of a glass base plate and a cyclic olefin polymer film. It is possible to interchange the positions of the first member and the second member.

The forms of the first member and the second member are not particularly limited and examples thereof include a sheet, a flat-plate and the like.

The first member and the second member are not particularly limited and examples thereof include a polarizing plate, a wave plate, a retardation plate, an optical compensation film, a brightness enhancing film, a light guide plate, a reflective film, an anti-reflective film, a transparent conductive film (such as an ITO film), a design film, a decoration film, a surface protective film, a film sensor, a liquid crystal display device, a liquid crystal panel, an organic EL (electroluminescence) display device, a PDP (plasma display panel) and cover glass.

### Specific Embodiment (2) of Manufacturing Method of the Present Disclosure

The specific embodiment (2) is an example of the method for manufacturing an optical member, the method including the step (i), the step (ii) and the step (iv). The specific embodiment (2) is an example of the method for manufacturing an optical member, the method including a step of forming a printed layer on one surface of a sheet substrate or flat-plate substrate (corresponding to the step (i)), a step of coating a pressure-sensitive adhesive selected from the group consisting of a hot melt pressure-sensitive adhesive and an active energy-ray curable pressure-sensitive adhesive on the surface on the printed layer side of the substrate and forming a pressure-sensitive adhesive layer of the pressure-sensitive adhesive (corresponding to the step (ii)), and a step of laminating a member (corresponding to the member (III)) to the pressure-sensitive adhesive layer (corresponding to the step (iv)).

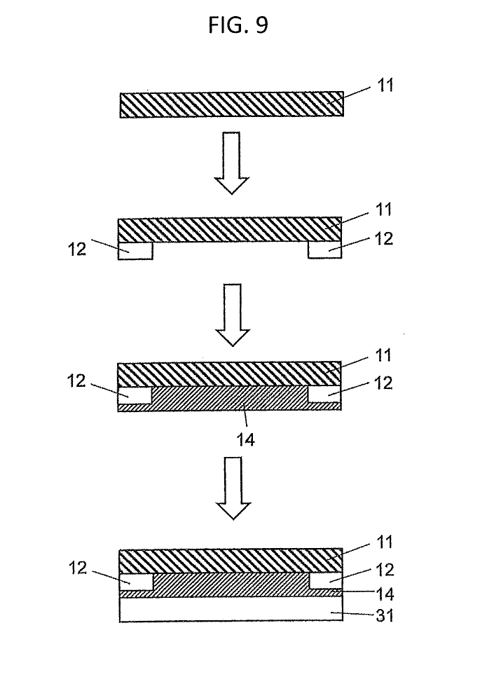

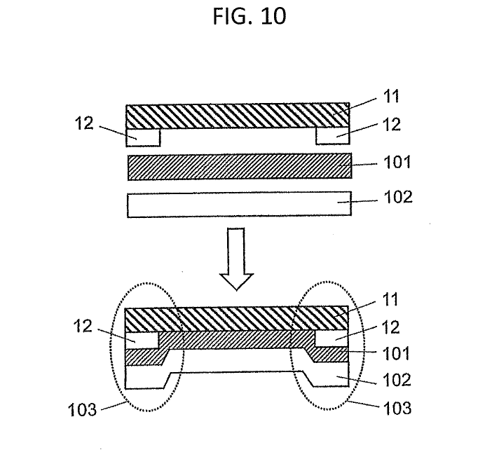

FIG. 9 is a schematic diagram showing an example of the specific embodiment (2) of the method for manufacturing an optical member in one aspect of the present disclosure. The printed layer 12 is first formed on one surface of the sheet substrate or flat-plate substrate 11. Next, the pressure-sensitive adhesive layer 14 of the present disclosure is formed on the surface on the printed layer 12 side of the sheet substrate or flat-plate substrate 11. Then, the member 31 is laminated to the pressure-sensitive adhesive layer 14 of the present disclosure, and thus, the laminate is produced.

The sheet substrate or flat-plate substrate and the member in the specific embodiment (2) are each selected from the sheet substrate or flat-plate substrate and the member (III) described above. The combination of the sheet substrate or flat-plate substrate and the member in the specific embodiment (2) is not particularly limited and preferable examples thereof include a combination of a glass substrate and a plastic film, and a combination of a plastic base plate and a plastic film. It is possible to interchange the positions of the sheet substrate or flat-plate substrate and the member in the specific embodiment (2).

### (Optical Member)

The optical member manufactured by the manufacturing method in one aspect of the present disclosure is a member having optical properties (such as polarization property, light refraction property, light scattering property, light reflectivity, light transmission property, light absorption property, light diffraction property, optical rotation property and visibility). The optical member is not particularly limited as long as it is a member having optical properties. Examples thereof include a member constituting a device such as a display device (an image display device) and an input device, or a member used for such a device. More specific examples thereof include a polarizing plate, a wave plate, a retardation plate, an optical compensation film, a brightness enhancing film, a light guide plate, a reflective film, an anti-reflective film, a transparent conductive film (such as an ITO film), a design film, a decoration film, a surface protective film, a prism, lens, a color filter, a transparent base plate, and a member in which these are laminated. The “plate” and the “film” above each include the meansings of forms such as a plate form, a film form and a sheet form, and for example, the “polarizing plate” also includes the meaning of “a polarizing film” and “a polarizing sheet”.

Examples of the display device include a liquid crystal display device, an organic EL (electroluminescence) display device, a PDP (plasma display panel) and an electronic paper. Further, examples of the input device include a touch panel and the like.

The optical member manufactured by the manufacturing method in one aspect of the present disclosure is not particularly limited and is preferably a member constituting a touch panel or a touch panel among the members above.

### EXAMPLES

The present invention will now be described in further detail based on the Examples. However, these Examples should not be construed as limiting the scope of the present invention.

The manufacturing conditions and the evaluation results of optical members manufactured based on the Examples and Comparative Examples are shown in Table 1.

### Example 1

### Preparation of Prepolymer Composition

To a monomer mixture of 57 parts by weight of 2-ethylhexyl acrylate (2EHA), 22 parts by weight of isobornyl acrylate (IBXA) and 21 parts by weight of 2-hydroxyethyl acrylate (HEA), 0.05 parts by weight of trade name “IRGACURE 184” (manufactured by Ciba Specialty Chemicals Inc.) and 0.05 parts by weight of trade name “IRGACURE 651” (manufactured by Ciba Specialty Chemicals Inc.) as photopolymerization initiators were added, and then the mixture was irradiated with UV ray with an illumination intensity of 5.0 mW/cm² for 120 seconds using a black light (manufactured by Toshiba Corporation) until the viscosity (measured by BH viscometer, No. 5 rotor, 10 rpm, measurement temperature of 30° C.) reached about 20 Pa·s. And then, a prepolymer composition in which the monomer components were partially polymerized was prepared.

### (Preparation of Pressure-Sensitive Adhesive)

To the prepolymer composition above (100 parts by weight), 0.06 parts by weight of dipentaerythritol hexaacrylate (DPHA) (manufactured by Nippon Kayaku Co., Ltd., trade name “KAYARAD DPHA-40H”) was added, and a pressure-sensitive adhesive (an active energy-ray curable pressure-sensitive adhesive) was prepared.

### (Production of Optical Member)

Using a PET film having a thickness of 25 μm (PET#25) as the sheet substrate or flat-plate substrate, a printed layer was formed on the PET#25 by screen printing method and a design film was produced (the thickness of the printed layer: 45 μm). The pressure-sensitive adhesive (the active energy-ray curable pressure-sensitive adhesive) prepared above was coated on the surface on the printed layer side of the design film with a roll coater in such a way that the final thickness of the pressure-sensitive adhesive layer became 100 μm, and a PET separator (manufactured by Mitsubishi Plastics, Inc., trade name “MRF38”) for insulating oxygen was lamianted to the pressure-sensitive adhesive surface to thereby form a laminate. The PET separator side of the laminate was irradiated with UV ray (illumination intensity: 5 mW/cm², irradiation time: 300 seconds) using a black light (manufactured by Toshiba Corporation) to cure the pressure-sensitive adhesive, thereby forming a pressure-sensitive adhesive layer. Then, the PET separator was removed and the residual monomers were volatilized by heat treatment in a drying machine at 130° C. for 2 minutes to produce a laminate. The laminate produced was stored as a laminate (b1) in the state where a PET separator (manufactured by Mitsubishi Plastics, Inc., trade name “MRF38”) was laminated to the pressure-sensitive adhesive layer surface of the laminate.

The PET separator of the laminate (b1) produced above was removed and the pressure-sensitive adhesive layer surface was laminated to glass. A PET film having a thickness of 100 nm (PET#100) to which a pressure-sensitive adhesive sheet (manufactured by Nitto Denko Corporation, trade name “CS9622T”) had been attached was laminated to the PET#25 of the laminate (b1). Then, by conducting autoclave treatment at 50° C. under 0.5 MPa for 15 minutes, an optical member was produced.

### Example 2

A laminate (b2) and an optical member were produced by the same method as in Example 1 except that the thickness of the printed layer was changed to 75 μm.

### Example 3

A laminate (b3) and an optical member were produced by the same method as in Example 2 except that the pressure-sensitive adhesive layer was formed in such a way that the final thickness of the pressure-sensitive adhesive layer became 80 μm.

### Example 4

A laminate (b4) and an optical member were produced by the same method as in Example 1 except that a PET film having a thickness of 50 μm (PET#50) was used as the sheet substrate or flat-plate substrate.

### Comparative Example 1

### Production of Pressure-Sensitive Adhesive Sheet

The pressure-sensitive adhesive prepared in Example 1 was coated on a PET separator having a thickness of 75 μm (manufactured by Mitsubishi Plastics, Inc., trade name “MRF75”) with a roll coater in such a way that the final thickness of the pressure-sensitive adhesive layer became 100 μm, and a PET separator (manufactured by Mitsubishi Plastics, Inc., trade name “MRF38”) for insulating oxygen was laminated to the pressure-sensitive adhesive surface to thereby form a laminate. The PET separator (MRF38) side of the laminate was irradiated with UV ray (illumination intensity: 5 mW/cm², irradiation time: 300 seconds) using a black light (manufactured by Toshiba Corporation) to curing the pressure-sensitive adhesive, thereby forming a pressure-sensitive adhesive layer. Then, the PET separator on one surface was removed and the residual monomers were volatilized by heat treatment in a drying machine at 130° C. for 2 minutes to produce a substrateless type pressure-sensitive adhesive sheet (thickness: 100 μm). The pressure-sensitive adhesive sheet produced was laminated to a PET separator (manufactured by Mitsubishi Plastics, Inc., trade name “MRF38”), thereby forming a pressure-sensitive adhesive sheet (X1).

### (Production of Optical Member)

Using glass having a thickness of 400 μm as the sheet substrate or flat-plate substrate, a printed layer was formed on the glass by screen printing method and design glass was produced (the thickness of the printed layer: 45 μm). A PET film having a thickness of 100 μm to which the pressure-sensitive adhesive sheet (X1) above after removing the PET separator had been attached was laminated to the surface on the printed layer side of the design glass through the pressure-sensitive adhesive sheet under 0.3 MPa. Then, an optical member (laminate (b5)) was produced by conducting autoclave treatment at 50° C. under 0.5 MPa for 15 minutes.

### Comparative Example 2

### Preparation of Prepolymer Composition

To a separable flask, 70 parts by weight of 2-methoxyethyl acrylate, 29 parts by weight of 2-ethylhexyl acrylate (2EHA) and 1 part by weight of 4-hydroxybutyl acrylate as monomer components, 0.2 parts by weight of 2,2′-azobisisobutyronitrile as a polymerization initiator, and 100 parts by weight of ethyl acetate as a polymerization solvent were introduced and the mixture was stirred for 1 hour while introducing nitrogen gas. After thus removing the oxygen in the polymerization system, the temperature was increased to 63° C. and the reaction was conducted for 10 hours. By adding toluene, an acrylic polymer solution having a solid content concentration of 25 wt % was obtained. The weight average molecular weight of the acrylic polymer in the acrylic polymer solution was 1,500,000.

### (Preparation of Pressure-Sensitive Adhesive)

To 100 parts by weight of the acrylic polymer solution in terms of the solid contents, 0.7 parts by weight of a polyfunctional isocyanate compound (manufactured by Nippon Polyurethane Industry Co., Ltd., trade name “CORONATE HL”) was added as a cross-linking agent and a pressure-sensitive adhesive (solution polymerization-type pressure-sensitive adhesive) was prepared.

### (Production of Optical Member)

Using a PET film having a thickness of 25 μm (PET#25) as the sheet substrate or flat-plate substrate, a printed layer was formed on the PET#25 by screen printing method and a design film was produced (the thickness of the printed layer: 45 μm). The pressure-sensitive adhesive (solution polymerization-type pressure-sensitive adhesive) prepared above was coated on the surface on the printed layer side of the design film with a roll coater in such a way that the thickness of the pressure-sensitive adhesive layer after heat drying became 100 μm, and a pressure-sensitive adhesive layer was formed by heat drying at 130° C. for 3 minutes. After the heat drying, a PET separator (manufactured by Mitsubishi Plastics, Inc., trade name “MRF38”) was laminated to the pressure-sensitive adhesive layer surface and aging was conducted at 50° C. for 24 hours to thereby produce a laminate (b6).

The PET separator of the laminate (b6) produced above was removed and the pressure-sensitive adhesive layer surface was laminated to glass. A pressure-sensitive adhesive sheet (manufactured by Nitto Denko Corporation, trade name “CS9622T”) was laminated to the PET#25 of the laminate (b6) and a PET film having a thickness of 100 μm (PET#100) was further laminated through the pressure-sensitive adhesive sheet. Then, an optical member was produced by conducting autoclave treatment at 50° C. under 0.5 MPa for 15 minutes.

### (Evaluation)

The workability, the warp and the warp index of each optical member obtained in the Examples and Comparative Examples were measured or evaluated by the following measuring method or evaluation method.

### (1) Workability

Optical members were prepared in the same manner as in each of Examples and Comparative Examples excpet that the printed layer was not formed and the pressure-sensitive adhesive layer or pressure-sensitive adhesive sheet was laminated to a separater, and thus evaluation samples were produced. The samples were fixed on glass plates and cut with a NT cutter at a rate of 1 m/s. At the time immediately after cutting and at the time after storing at 40° C. for 24 hours after cutting, the cut surfaces of the samples were observed and the separators were peeled, and the evaluation the workability was conducted under the following standard.

A: The pressure-sensitive adhesive layer did not bleed out from the cut surface and the separator could be peeled without any problems, both at the time immediately after cutting and at the time after storing at 40° C. for 24 hours after cutting.

C: The ommision of the pressure-sensitive adhesive layer occurred to some degrees or the separator was not smoothly peeled, both or either at the time immediately after cutting and at the time after storing at 40° C. for 24 hours after cutting.

### (2) Warp

The outermost surfaces of the sheet substrate or flat-plate substrate of the optical members obtained in the Examples and Comparative Examples on the side opposite to the pressure-sensitive adhesive layer were visually observed with angle of 0 to 180° and the warp was evaluated with the following standard.

A: There was no warp.

C: There was warp.

### (3) Warp Index

Regarding each of the laminates (b1) to (b6) obtained in the Examples and Comparative Examples, the separator was removed if any separator had been provided on the pressure-sensitive adhesive layer surface, and a PET film was laminated to the pressure-sensitive adhesive layer side or the pressure-sensitive adhesive sheet side of the laminates (b1) to (b6). The surface roughness of the outermost surface of the laminated PET film side (the side opposite to the sheet substrate or flat-plate substrate side) was measured using a scanning profilometer (KLA Tencor P-15). The max value (maximum value) and the min value (minimum value) of the surface roughness were calculated and the warp index was determined by the following formula (A).

Warp Index(μm)=(max value)−(min value) (A)

TABLE 1

| | | | | | Comparative | Comparative |
|---|---|---|---|---|---|---|
| | Example 1 | Example 2 | Example 3 | Example 4 | Example 1 | Example 2 |
| Thickness of sheet substrate or | 25 | 25 | 25 | 50 | 400 | 25 |
| flat-plate substrate [μm] | | | | | | |
| Thickness of printed layer [μm] | 45 | 75 | 75 | 45 | 45 | 45 |
| Thickness of pressure-sensitive | 100 | 100 | 80 | 100 | 100 | 100 |
| adhesive layer [μm] | | | | | | |
| Curing method of pressure- | UV | UV | UV | UV | UV irradiation | Solution |
| sensitive adhesive | irradiation | irradiation | irradiation | irradiation | | polymerization |
| Forming method of pressure- | Forming after | Forming | Forming | Forming | Lamination of | Forming after |
| sensitive adhesive layer | coating | after coating | after coating | after coating | sheet | coating |
| Workability | A | A | A | A | A | A |
| Warp | A | A | A | A | C | C |
| Warp index [μm] | 0 | 0 | 0 | 0 | 36.0 | 10.2 |

As is clear from Table 1, the optical members manufactured by the manufacturing methods in one aspect of the present disclosure (Examples 1 to 4) had no warp and had an excellent appearance. On the other hand, the optical members manufactured by methods which were not the manufacturing method of the present disclosure (Comparative Examples 1 and 2) had remarkable warp and had a bad appearance.

While the invention has been described in detail and with reference to specific embodiments thereof, it will be apparent to one skilled in the art that various changes and modifications can be made therein without departing from the spirit and scope thereof.

This application is based on Japanese Patent Application No. 2013-094882 filed on Apr. 30, 2013, the entire subject matter of which is incorporated herein by reference.

### DESCRIPTION OF REFERENCE NUMERALS AND SIGNS

11: Sheet substrate or flat-plate substrate (substrate)
12: Printed layer
13: Laminate (a)
14: Pressure-sensitive adhesive layer of the present disclosure
15: Laminate (b)
21: Other pressure-sensitive adhesive layer
22: Member (I)
23: Member (II)
24: Laminate
31: Member (III)
32: Laminate
71: First pressure-sensitive adhesive layer
72: Second pressure-sensitive adhesive layer
73: First member
74: Second member
81: Laminate
101: Double-sided pressure-sensitive adhesive sheet
102: Film such as film sensor
103: Warp part

What is claimed is:

1. A method for manufacturing an optical member, comprising:
forming a printed layer on one surface of a sheet substrate or flat-plate substrate; and
coating one or more pressure-sensitive adhesives selected from the group consisting of a hot melt pressure-sensitive adhesive and an active energy-ray curable pressure-sensitive adhesive on a surface on a printed layer side of the sheet substrate or flat-plate substrate, and forming a pressure-sensitive adhesive layer of the pressure-sensitive adhesive.

2. The method according to claim 1, wherein a warp index of the optical member manufactured is 0 to 0.5 μm, the warp index being defined below:
warp index: when a polyethylene terephthalate film having a thickness of 100 μm is laminated to a surface of the pressure-sensitive adhesive layer of the optical member manufactured, a surface roughness of a surface of the polyethylene terephthalate film on the side opposite to the pressure-sensitive adhesive layer is measured, the max value and min value of the surface roughness is calculated, and the warp index is determined by the following formula (A).
warp index(μm)=(max value)−(min value) (A)
